(19) United States
(12) Patent Application Publication
(10) Pub. No.: US 2015/0214585 A1
(43) Pub. Date: Jul. 30, 2015

(54) BATTERY DEVICE AND BATTERY PACK

(71) Applicants: UER TECHNOLOGY (SHENZHEN) LIMITED, Shenzhen (CN); UER TECHNOLOGY CORPORATION, Miaoli County (TW)

(72) Inventors: RAY-TANG SUN, Miaoli (TW); TSUNG-HSIEN CHUANG, Miaoli (TW); CHENG-GHI FANG, Miaoli (TW); WEN-HSIEN CHEN, Miaoli (TW)

(21) Appl. No.: 14/576,935

(22) Filed: Dec. 19, 2014

(30) Foreign Application Priority Data
Jan. 27, 2014 (TW) 103102827

(51) Int. Cl. H01M 10/6551; H01M 2/20

(52) U.S. Cl. CPC H01M 10/6551; H01M 10/6552; H01M 2/202; H01M 2/204; H01M 2/206

(57) ABSTRACT

A battery pack includes a housing, a number of battery cells received in the housing, and an electrical connection plate module for connecting the battery cells together. The housing defines a number of heat dissipating grooves. The battery pack further includes a number of electrically-insulated heat conductive pads received in the heat dissipating grooves and at least one heat conductive plate. The heat conductive plate forms a number of first protrusions and is mounted on the housing. The first protrusions extend into the heat dissipating grooves pressing the electrically-insulated heat conductive pads close to the electrical connection plate module.

### FIELD

The subject matter herein generally relates to a battery device, and particularly to a battery device combined with a plurality of battery packs.

### BACKGROUND

A battery device assembled by a plurality of interconnected battery cells will produce large amounts of heat during operation. If the heat is not dissipated in a timely manner, the temperature of the battery device increases and the battery device can fail to function properly.

### BRIEF DESCRIPTION OF THE DRAWING

Many aspects of the disclosure can be better understood with reference to the following drawing. The components in the drawing are not necessarily drawn to scale, the emphasis instead being placed upon clearly illustrating the principles of the disclosure. Implementations of the present technology will now be described, by way of example only, with reference to the attached figure.

FIG. 1 is an isometric, exploded view of a battery device according to the present disclosure.

FIG. 2 is a partially assembled, isometric view of a battery device of FIG. 1 according to the present disclosure.

FIG. 3 is an assembled, isometric view of a battery device of FIG. 1 according to the present disclosure.

FIG. 4 is an isometric view of a battery pack in the battery device of FIG. 1 according to the present disclosure.

FIG. 5 is an isometric, exploded view of a battery pack of FIG. 4 according to the present disclosure.

FIG. 6 is an isometric, exploded view of a battery pack of FIG. 5 from another angle according to the present disclosure.

FIG. 7 is a cross sectional view of a battery pack along a line VII-VII of FIG. 4.

FIG. 8 is an enlarged view of a battery pack according to the VIII portion of FIG. 7.

FIG. 9 is an isometric view of a half-housing of a battery pack of FIG. 5 according to the present disclosure.

FIG. 10 is an enlarged view of a battery pack according to the X portion of FIG. 6.

FIG. 11 is an enlarged view of a battery pack according to the XI portion of FIG. 6.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

A battery device comprising a plurality of battery packs and a heat dissipation unit is described. The disclosure is illustrated by way of example and not by way of limitation in the accompanying drawing. It should be noted that references to “an” or “one” embodiment in this disclosure are not necessarily to the same embodiment, and such references mean “at least one.”

A battery pack comprises a housing, a plurality of battery cells received in the interior space of the housing, and an electrical connection plate module for connecting the plurality of battery cells together. The battery pack further includes a plurality of electrically-insulated heat conductive pads and at least one heat conductive plate. The housing defines at least one first receiving groove with an open end for receiving a corresponding heat conductive plate, and the housing also defines a number of heat dissipating grooves which penetrate through the housing from the open end of the first receiving groove. The first receiving groove corresponding to the heat dissipating grooves is far from the battery cell. The electrically-insulated heat conductive pads are received in the heat dissipating grooves. The heat conductive plate has a number of first protrusions and is received in the first receiving groove. The first protrusions slide into the heat dissipating grooves to press the electrically-insulated heat conductive pads close the electrical connection plate module.

A battery device comprises a base, a battery module disposed on the base and a heat dissipation unit connecting to the battery module. The battery module includes at least one battery-pair structure, the battery-pair structure comprises two battery packs as described above, which stand side by side and are spaced from each other. The heat dissipation unit includes at least one heat conductive element corresponding to the battery-pair structure. The heat conductive element is across a gap defined between the two battery cells of the battery-pair structure and connects to the heat conductive plates of the battery-pair structure. The heat conductive element includes a plurality of strip-shaped heat conductive members. The heat conductive members are at a divergent state on the heat conductive plate of the battery pack, and are at a concentrated state between intervals of the battery packs.

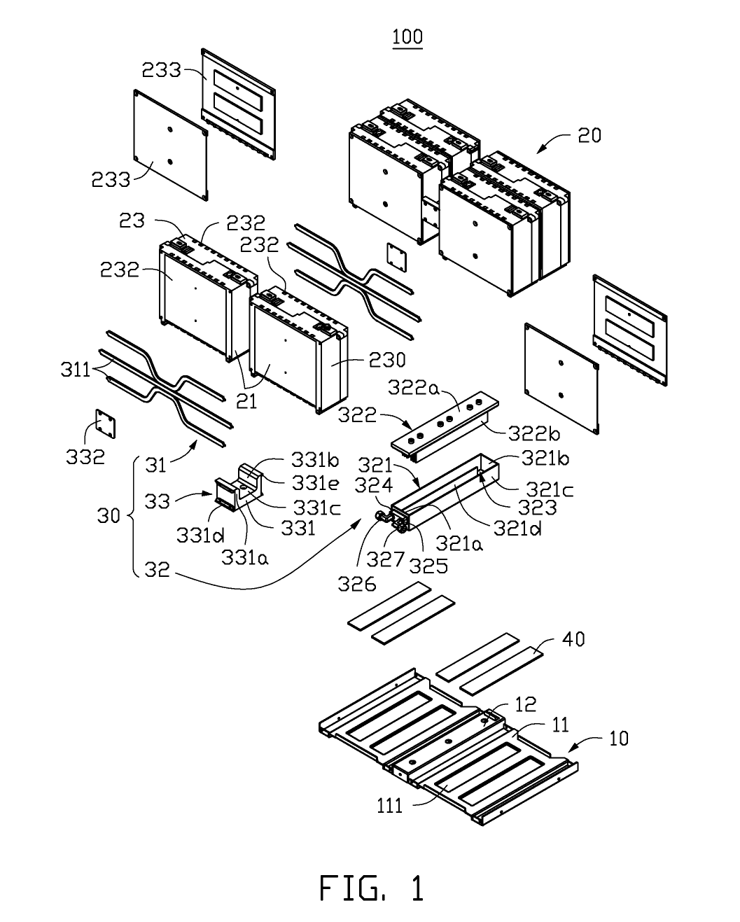

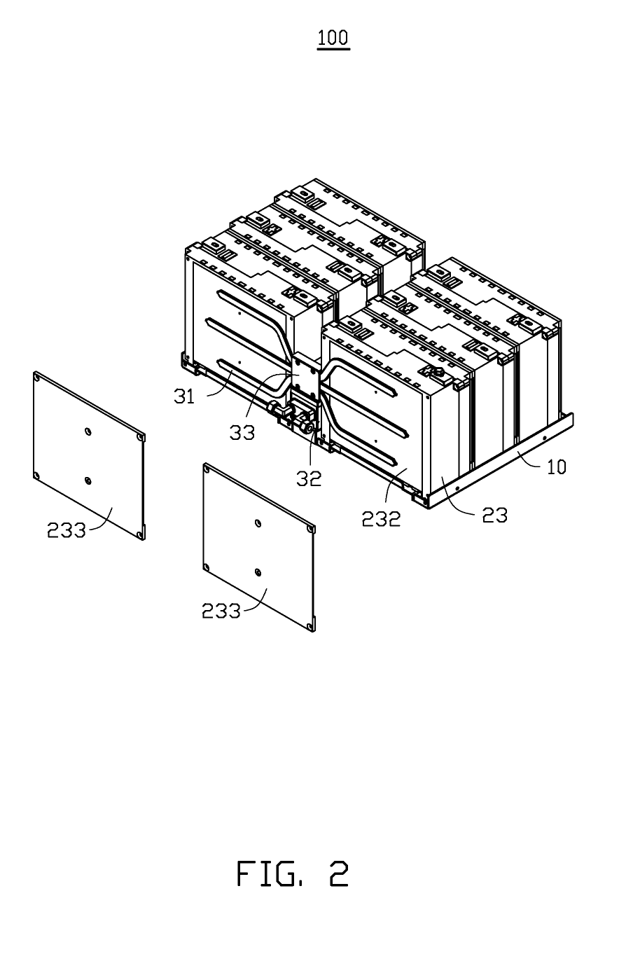

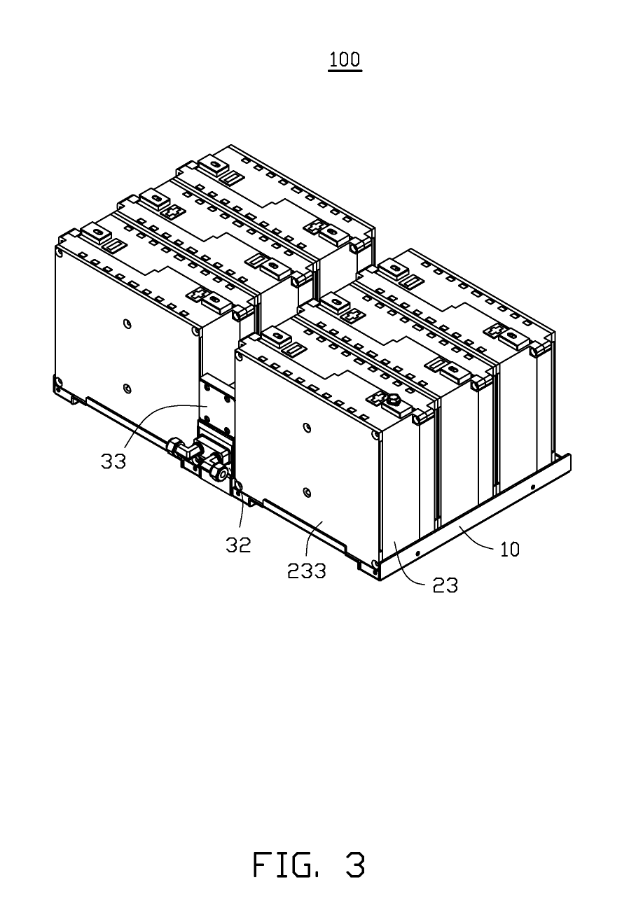

FIG. 1 to FIG. 3 and FIG. 7 illustrate that a battery device 100 includes a base 10, a battery module 20, and a heat dissipation unit 30.

The base 10 is used to hold and carry the battery module 20 and the dissipation unit 30. The base 10 defines a first support area 11 for holding and carrying the battery module 20, and a second support area 12 for holding and carrying the heat dissipation unit 30. The second support area 12 is positioned at the central region of the first support area 11. In this embodiment, the second support area 12 with an elongated-strip shape is positioned between two first support areas 11 horizontally and has a thickness larger than the thickness of the first support area 11 to form a projecting stage.

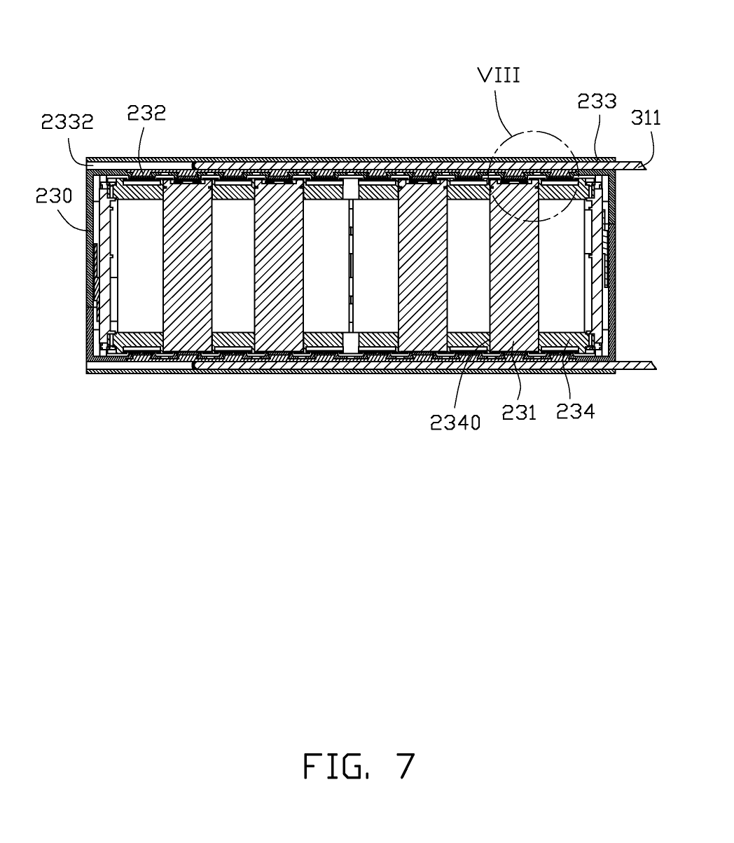

The battery module 20 includes a plurality of battery-pair structures 21. Each of the battery-pair structures 21 includes two battery packs 23 which stand side by side and are spaced from each others. The plurality of battery-pair structures 21 are sequentially stacked to constitute a battery module 20. In this embodiment, the number of the battery-pair structures 21 is three. In other embodiments, the number of battery-pair structures 21 can be increased or decreased and is not limited to this embodiment. Each of the battery packs 23 includes a housing 230, a plurality of battery cells 231 received in the housing 230 and shown in FIG. 7, two heat conductive plates 232 disposed on the front end and back end of the housing 230, and two outer covers 233 fixed on the housing 230 to cover the heat conductive plates 232. The structure of the battery pack 23 will be described in more detail below.

The heat dissipation unit 30 is used for cooling the battery module 20. The heat dissipation unit 30 includes a plurality of heat conductive elements 31, a cooling block 32 and a plurality of connecting portions 33. The plurality of heat conductive elements 31 are used to transport the heat generated by the battery packs 23. In this embodiment, each of the battery-pair structures 21 is associated with two heat conductive elements 31; the two heat conductive elements 31 are respectively disposed on the heat conductive plates 232 of the battery packs 23 of the corresponding battery-pair structure 21. Each of the heat conductive elements 31 includes a plurality of double sided fork-shaped heat conductive members 311, the heat conductive members 311 correspond to the central region of the heat conductive element 31 at a concentrated state, and the corresponding ends of the heat conductive element 31 are at a divergent state. The heat conductive members 311 are made by the materials with a high thermal conductivity, such as copper, aluminum and the like. In this embodiment, the heat conductive member 311 is a heat pipe with an internal heat exchange function to more efficiently dissipate the heat generated by the battery packs 23. It should be understood that the number of the heat conductive members 311 for each of the heat conductive elements 31 can be appropriately changed based on different applications and not limited by the present embodiment.

The cooling block 32 is used for cooling and dispersing the accumulated heat generated by the heat conductive elements 31. The cooling block 32 includes a rectangular cup shaped bottom holder 321 and an upper cover 322. The bottom holder 321 includes a first end wall 321a, a second end wall 321b opposite to the first end wall 321a, and two first side walls 321c which are connected with the first end wall 321a and the second end wall 321b. In this embodiment, the first end wall 321a is substantially parallel to the second end wall 321b, and the first side walls 321c are substantially perpendicular to the first end wall 321a and the second end wall 321b. The first end wall 321a, the second end wall 321b and the first side walls 321c together define a receiving space 323, and the receiving space 323 is used for accommodating a cooling fluid (not shown).

The first end wall 321a defines a first through hole 324 and a second through hole 325, the first through hole 324 and the second through hole 325 communicate between the receiving space 323 and the outside space of the cooling block 32. The first through hole 324 is connected with a first pipe joint 326, and the second through hole 325 is connected with a second pipe joint 327. The first pipe joint 326 and the second pipe joint 327 are used to respectively connect the inlet tube (not shown) and the outlet tube (not shown) in order to achieve a cyclically continuous flow loop of the cooling fluid received in the receiving space 323. The bottom holder 321 further includes a partition plate 321d disposed within the receiving space 323. The partition plate 321d is connected to the first end wall 321a and extends a distance toward the second end wall 321b. The partition plate 321d toward to the second end wall 321b has a predetermined distance away from the second end wall 321b. The partition plate 321d is connected to the first end wall 321a at a position which is located between the first through hole 324 and the second through hole 325. The partition plate 321d is used to increase the flowing distance of the cooling fluid within the receiving space 323. The heat transferred to the cooling block 32 can be more efficiently taken away by the cooling fluid. The partition plate 321d enhances the utilization of the cooling liquid in the receiving space 323 and ensures the cooling effect and the heat dissipation efficiency of the cooling block 32.

The upper cover 322 and the bottom holder 321 are coupled to enclose the receiving space 323. The upper cover 322 includes a plate-shaped lid member 322a and a plurality of fins 322b connecting to the lid member 322a. The fins 322b are disposed on a side of the lid member 322a toward the receiving space 323. The fins 322b are arranged substantially parallel to each other and parallel to the first side walls 321c. When the upper cover 322 is closed with the bottom holder 321, the cooling fins 322b extend into the receiving space 323, and a portion of the fins 322b are located at one side of the partition plate 321d. The other portion of the fins 322b are located on the other side of the partition plate 321d. The lid member 322a and the fins 322b are made of high thermally conductive materials. In this embodiment, the lid member 322a and the fins 322b are made by an integrally molding the same materials. The fins 322b are set to divide the flowing cooling fluid in the receiving space 323 into a plurality of cooling fluid flowing beams so that the flowing cooling fluid can more uniformly and efficiently take away the heat transferred to the cooling block 32. Therefore, the fins 322b further enhance the cooling fluid utilization and ensure the cooling effect and the heat dissipation efficiency of the cooling block 32.

The connecting portion 33 is used to connect the heat conductive element 31 and the cooling block 32, and to transfer the heat from the heat conductive element 31 to the cooling block 32. The number of the connecting portions 33 corresponds to the number of batter-pair structures 21. Each of the connecting portions 33 includes a connecting block 331 and two connecting plates 332. The connecting block 331 includes a first connecting end 331a and a second connecting end 331b opposite to the first connecting end 331a. In the present embodiment, a recess 331c is located at the intermediate portion of the first connecting end 331a and the second connecting end 331b, so that the connecting block 331 is substantially U-shaped. The connecting block 331 can be other shapes and not limited to U-shaped. The end surface of the first connecting end 331a has two edges opposite to each other, and each of the edges has a first protrusion portion 331d. In addition, the end surface of the second connecting end 331b also has two edges opposite to each other, and each of the edges has a second protrusion portion 331e. The first protrusion portion 331d and the second protrusion portion 331e are parallel to each other and parallel to the arrangement direction of the two battery packs 23 in the battery-pair structure 21. The connecting plates 332 are used for connecting the first connecting end 331a and the second connecting end 331b, respectively. The connecting plates 332 can be attached and fixed by screws, bolts or the like.

The battery device 100 further includes a plurality of liquid absorbent sheets 40 which is located at a position between the base 10 and the battery module 20. The liquid absorbent sheet 40 can absorb the electrolyte leaked from the battery packs 23 of the battery module 20, and prevent the pollution from leaking the electrolyte to outside space of the battery modules 20. The liquid absorbent sheet 40 can be a liquid absorption polymer material, such as sponge or foam. In this embodiment, each of the liquid absorbent sheets 40 is elongated-strip shaped, and a length direction of the liquid absorbent sheet is parallel to the stacking direction of the battery-pair structures 21. The amount and the shape of the liquid absorbent sheet 40 can be changed and not limited to the present embodiment. Corresponding to the liquid absorbent sheet 40, the first support area 11 of the base 10 defines a plurality of slots 111 to receive the liquid absorbent sheet 40.

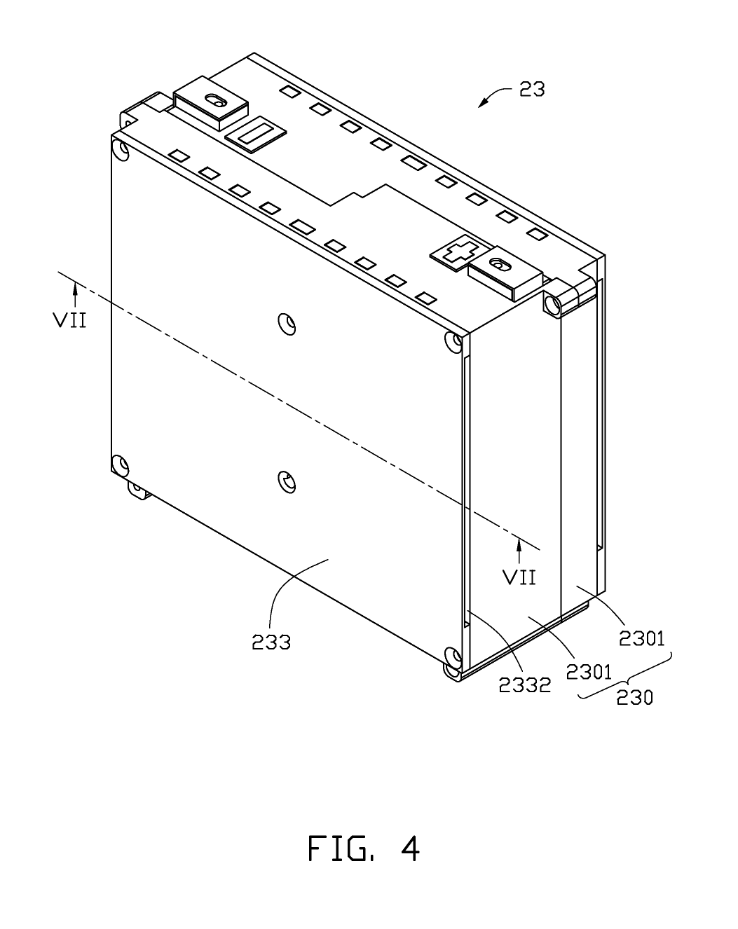

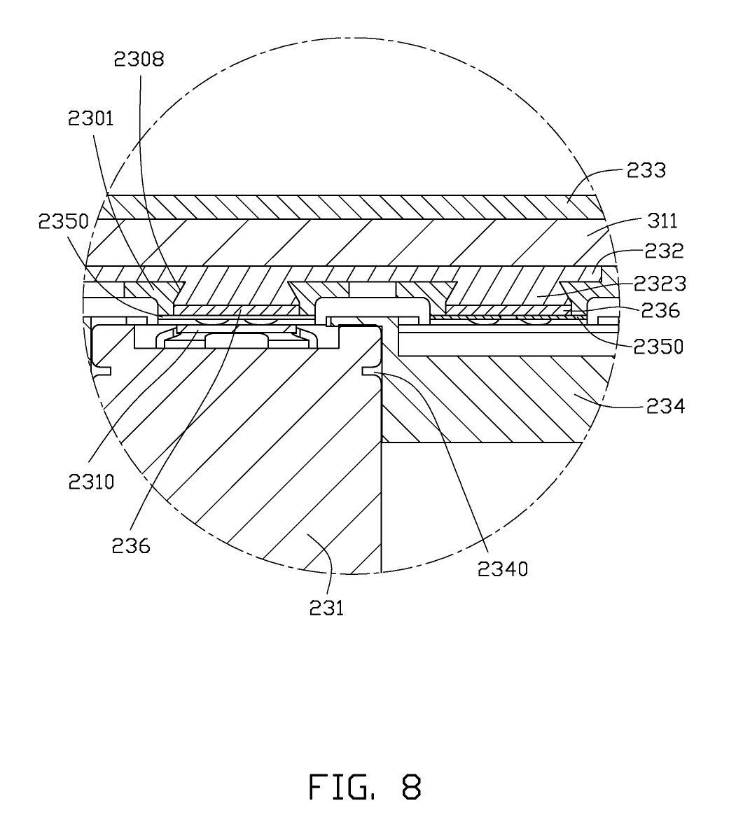

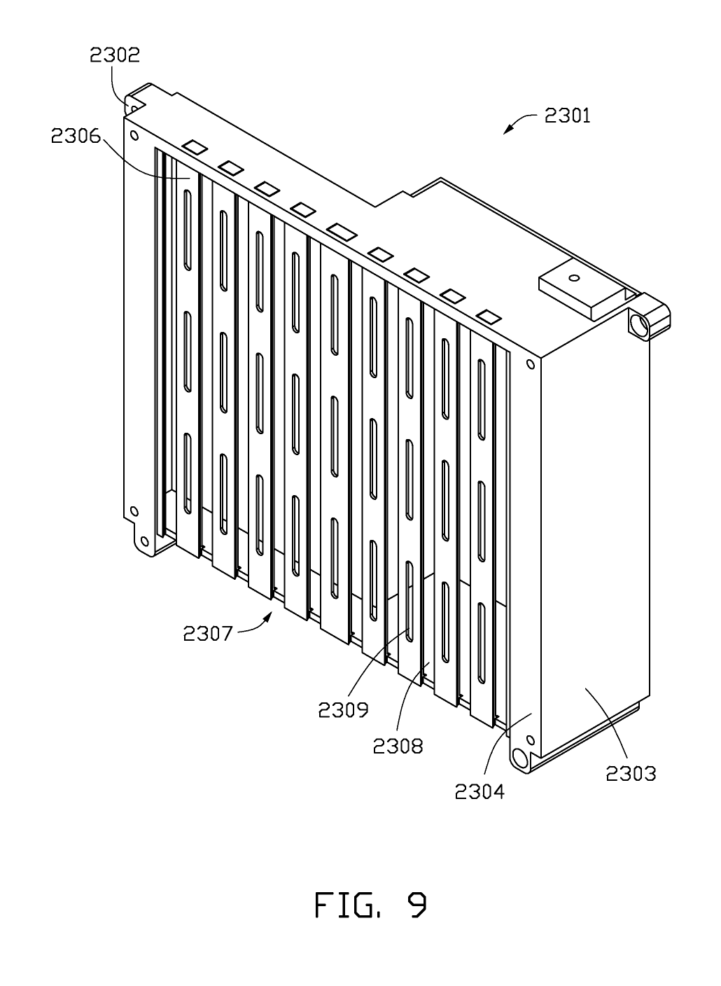

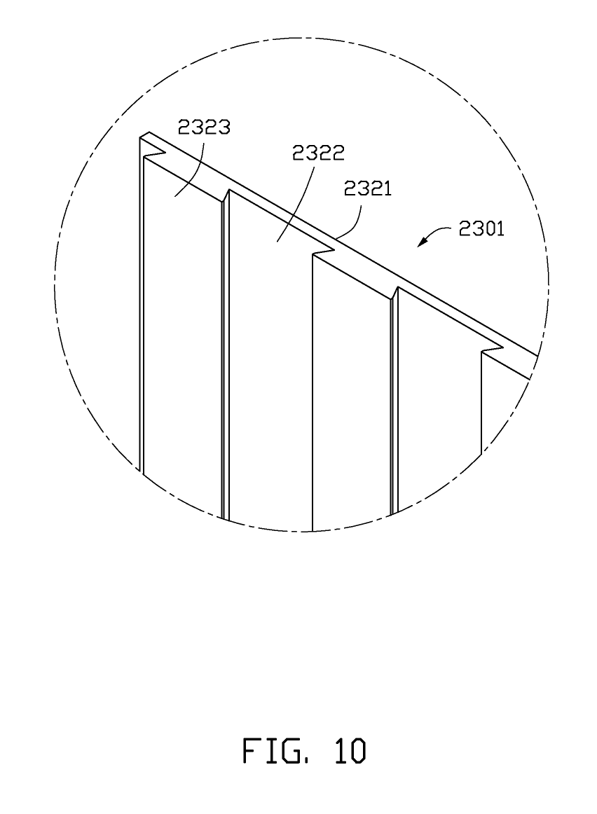

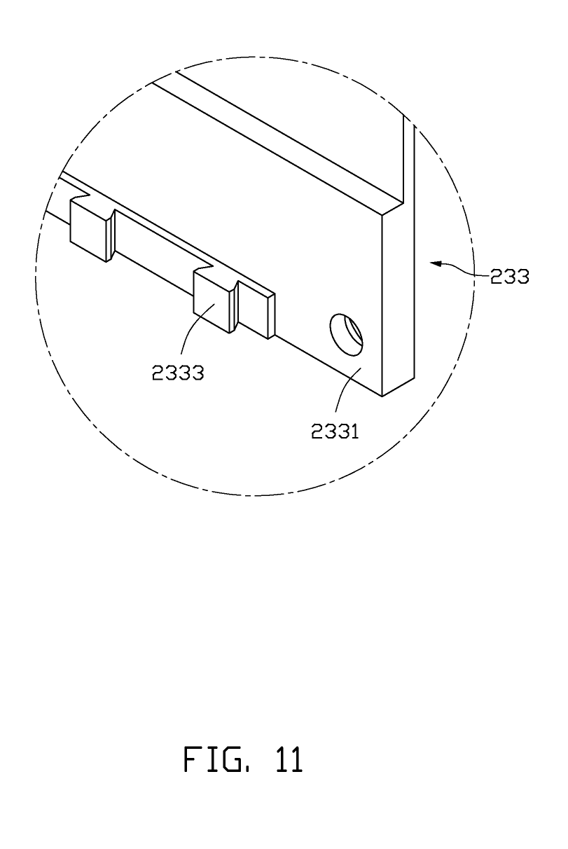

FIG. 4 to FIG. 11 illustrate that the structure of the battery packs 23 in more details. Each of the battery packs 23 further includes a frame 234, an electrical connection plate module 235, and a plurality of electrically-insulated heat conductive pads 236.

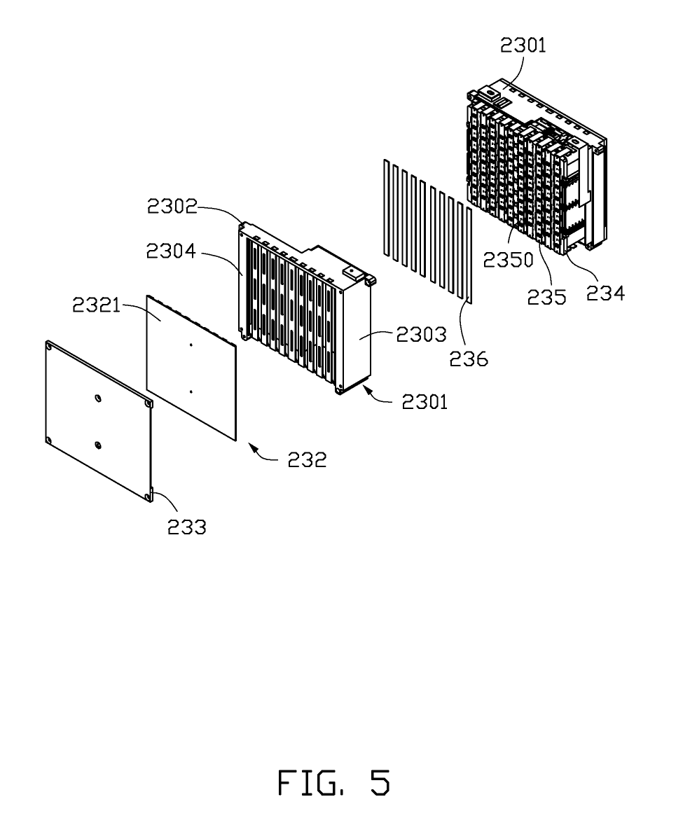

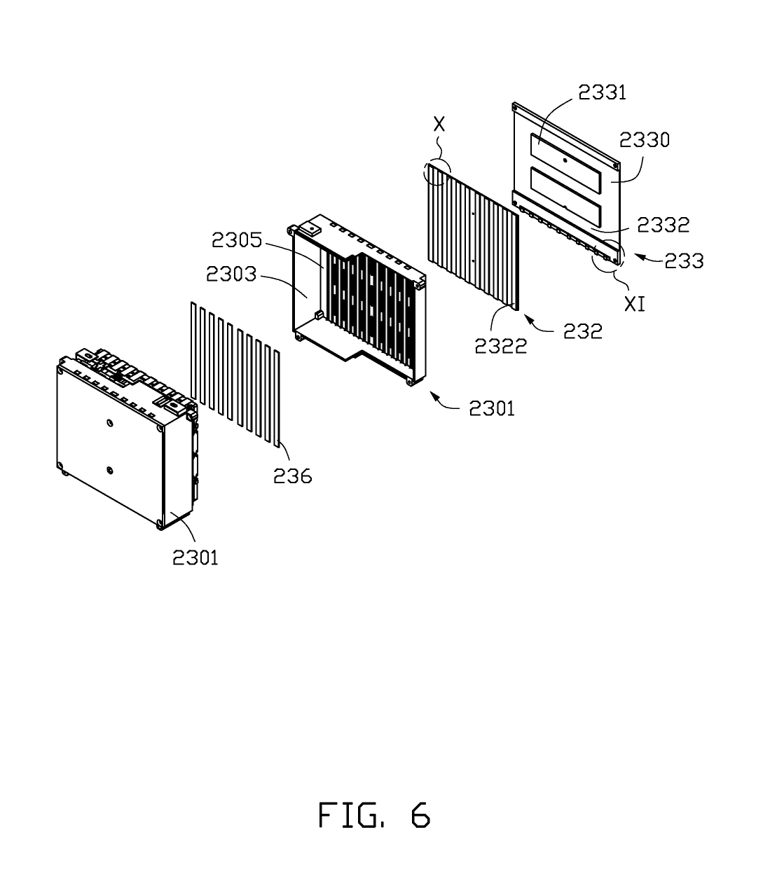

The front-end and rear-end structures of the battery packs 23 are symmetrical. Therefore, FIG. 5 and FIG. 6 are exploded views of the battery pack 23 based on the structure of one end of the battery pack 23. The structure of the other end of the battery pack 23 also has the same components and structures.

The frame 234 defines a plurality of receiving holes 2340 arranged in a plurality of rows, the battery cells 231 are received in the respective receiving holes 2340 of the frame 234 and arranged as a plurality of rows. The battery cells 231 are arranged at different rows and are staggered to accommodate more battery cells 231 on the same area of the frame 234.

The battery cell 231 further has two electrodes 2310 extending from the receiving holes 2340; the two electrodes 2310 are exposed to the outside of the frame 234. The two electrodes 2310 are a positive electrode and a negative electrode of the battery cell 231, respectively.

The electrical connection plates module 235 includes a plurality of electrical connection plates 2350 made by electrically connective and heat conductive metals. In the present embodiment, the electrical connection plates 2350 are made of copper alloys. The electrical connection plates 2350 are welded to the electrodes 2310, so that the different battery cells 231 can be connected together. It includes a series connection for the battery cells 231 on the same row and a parallel connection for the battery cells 231 on different rows. The heat generated by the battery cell 231 will be transmitted to electrical connection plates 2350 through the electrodes 2310 and the shell of the battery cell 231.

The electrically-insulated heat conductive pad 236 is elongated-strip shaped, and each of the electrically-insulated heat conductive pads 236 corresponds to one pole of a row of battery cells 231. That is, the two opposite electrodes 2310 for each row of battery cells 231 corresponds to two electrically-insulated heat conductive pads 236. The electrically-insulated heat conductive pad 236 is made of electrically-insulated materials with high thermal conductivity, such as silicone, rubber, or polymer materials. The electrically-insulated heat conductive pad 236 is attached on the electrical connection plate 2350 to absorb the heat transmitted from the electrical connection plate 2350.

The frame 234, the battery cells 231, the electrical connection plate module 235, and electrically-insulated heat conductive pads 236 are received in the housing 230. The housing 230 can be made by plastics. The housing 230 defines an interior space and is composed of two half-housings 2301, the shapes of the two half-housings 2301 are complementary to each other, so that the two half-housings 2301 can form a complete housing 230 after being assembled together. The two half-housings 2301 can be connected together with a suitable connecting member, such as a screw, and fixed to the frame 234.

Each of the two half-housings 2301 includes a bottom wall 2302 and a second side wall 2303 which is vertically extending from the bottom wall 2302. The bottom wall 2302 includes a first outer surface 2304 and a first inner surface 2305 opposite to the first outer surface 2304, wherein the first outer surface 2304 corresponding to the first inner surface 2305 is away from the frame 234 and the battery cell 231, and the first inner surface 2305 is close to the frame 234 and the battery cell 231 corresponding to the first outer surface 2304. The first outer surface 2304 defines a plurality of the first receiving grooves 2306 to receive the heat conductive plates 232. The first receiving groove 2306 passes through the second side wall 2303 in one direction and is blocked by the second side walls 2303 in the other directions. That is, the first receiving groove 2306 has an open end 2307 to pass through the second side wall 2303. The bottom wall 2302 has a plurality of strip-shaped heat dissipating grooves 2308 which penetrate the first inner surface 2305 and communicate with the first receiving groove 2306. The extension direction of the heat dissipating grooves 2308 is perpendicular to the direction of the second side walls 2303 with an open end 2307, and the heat dissipating grooves 2308 penetrate through the second side wall 2303 at the open end 2307. The side of heat dissipating grooves 2308 communicating with the first receiving groove 2306 is a smaller side, and the other side of heat dissipating grooves 2308 adjacent to the first inner surfaces 2305 is a larger side. Each of the heat dissipating grooves 2308 corresponds to one of electrically-insulated heat conductive pads 236. The electrically-insulated heat conductive pad 236 is received in the heat dissipating grooves 2308 at the side adjacent to the first inner surface 2305 of the housing 230, and the electrically-insulated heat conductive pad 236 has a same size as that of the corresponding portion of the heat dissipating grooves 2308. On the bottom wall 2302, a plurality of strip-shaped heat dissipating through holes 2309 are formed between every two heat dissipating grooves 2308. The plurality of heat dissipating through holes 2309 not only make the half-housing 2301 lighter weight, but also dissipate the portion of heat generated by the battery cell 231 which is not transferred to the electrically-insulated heat conductive pad 236.

The heat conductive plate 232 is substantially plate-shaped, and each of heat conductive plates 232 corresponds to one end of the battery pack 23. The heat conductive plate 232 is mounted on the housing 230 and is close to a plurality of the electrically-insulated heat conductive pads 236 for transmitting the heat from the electrically-insulated heat conductive pads 236. Since the electrically-insulated heat conductive pad 236 is insulated, the heat conductive plate 232 can be made by an electrical conductive metal pad with a good thermal conductivity to enhance the structural strength of the heat conductive plate 232, but not to induce a short circuit of the battery cell 231. In the present embodiment, the heat conductive plate 232 is an aluminum plate.

The heat conductive plate 232 includes an second outer surface 2321 and an second inner surface 2322 opposite to second outer surface 2321. The second outer surface 2321 of the heat conductive plate 232 is a flat surface and the second inner surface 2322 of the heat conductive plate 232 is a convex surface formed with a plurality of first protrusions 2323 to couple with the heat dissipating grooves 2308. The length of the first protrusions 2323 is slightly less than the length of the heat dissipating grooves 2308. During installation, one end of the heat conductive plate 232 is placed into the first receiving groove 2306 from the open end 2307 of the first receiving groove 2306, and the first protrusions 2323 slide within the heat dissipating grooves 2308 and push the conductive plate toward the other end of the first receiving groove 2306. Then, the heat conductive plate 232 is completely received in the first receiving groove 2306. The first protrusions 2323 are close to the electrically-insulated heat conductive pad 236, and extend into the heat dissipating grooves 2308 to press the electrically-insulated heat conductive pad 236 close to the electrical connection plate module 235 for achieving excellent heat conduction. Because the electrically-insulated heat conductive pad 236 is made of silicone with an elastic characteristic; the pressure from first protrusions 2323 to the electrically-insulated heat conductive pad 236 will not damage the electrically-insulated heat conductive pad 236. Meanwhile, because the length of the first protrusion 2323 is slightly less than the length of heat dissipating groove 2308, the results are that the heat dissipating groove 2308 near the open end 2307 does not have the first protrusion 2323 inside the heat dissipating groove 2308.

The outer covers 233 are made of plastic materials. Each of the outer covers 233 has one corresponding heat conductive plate 232. The outer cover 233 is mounted on the housing 230 and is used to cover the heat conductive plate 232. The outer cover 233 includes a third inner surface 2330 formed with a plurality of projecting spacer blocks 2331; the spacer blocks 2331 are elongated-strip shaped and are spaced from each other so that a second receiving groove 2332 used to receive the heat conductive member 311 is formed in the gaps between the spacer blocks 2331. When the outer cover 233 is mounted on the housing 230, the second receiving groove 2332 is positioned between the outer cover 233 and the heat conductive plate 232 and contacts with the outside space. The heat conductive member 311 is inserted into the second receiving groove 2332 and contacts with the heat conductive plate 232.

The spacer block 2331 of the outer covers 233 near the open end 2307 is also formed with a plurality of second wedge-shaped protrusions 2333. The second protrusions 2333 are inserted into the heat dissipating groove 2308 to close the open end 2307 and to prevent the heat conductive plate 232 from sliding out of the first receiving groove 2306. The outer cover 233 can be fixed on the housing 230 by conventional methods, such as screws.

When assembling the battery device 100, the liquid absorbent sheet 40 is received in the slot 111 of the base 10, the liquid absorbent sheet 40 is fixed on the slot by adhesive or disposed on the slot 111 directly without adhesive. And then, the bottom holder 321 of the cooling block 32 is fixed on the second support area 12. The upper cover 322 is bonded to the bottom holder 321, so that the fins 322b extend into the receiving space 323. After assembling the cooling block 32, one of the connecting blocks 331 of the connecting portions 33 is fixed on the upper cover 322. The battery-pair structure 21 corresponding to the connecting portion 33 is disposed on the first support area 11, and the two battery packs 23 of the battery-pair structure 21 are respectively located at the different sides of the corresponding connecting block 331. The two heat conductive elements 31 corresponding to the battery-pair structure 21 are respectively disposed on the heat conductive plates 232 of the battery packs 23. The heat conductive elements 31 are across the gap between the two battery packs 23 and connect with the battery packs 23. When the heat conductive elements 31 are across the intermediate portion of the two battery packs 23, the heat conductive elements 31 pass through the end surfaces of the first connecting end 331a and the second connecting end 331b of the corresponding connecting portion 33, respectively. The first protrusion portions 331d of the connecting portion 33 engage a portion of the heat conductive element 31 which is located at the end surface of the first connecting end 331a. The second protrusion portions 331e of the connecting portion 33 engage a portion of the heat conductive element 31 which is located at the end surface of the second connecting end 331b. The outer cover 233 of the battery packs 23 is fixed to the housing 230, and the end portion of the heat conductive element 31 is fixed on the heat conductive plate 232 by the corresponding outer cover 233. The connecting plates 332 corresponding to the connecting portion 33 are fixed to the first connecting end 331a and the second connection end 331b of the connecting portion 33. The other battery-pair structure 21 and the corresponding connecting portion 33 can be assembled by a similar manner. After assembling the battery-pair structures 21, a plurality of the battery-pair structures 21 are stacked together to form the battery module 20.

When the battery device 100 operates, the first pipe joint 326 and the second pipe joint 327 are respectively connected to the inlet tube and the outlet tube to inject the cooling fluid into the receiving space 323 and flow the cooling fluid within the receiving space 323. The heat generated by the battery packs 23 of the battery module 20 transmits to the corresponding connecting portion 33 by passing through the corresponding heat conductive element 31. The connecting portion 33 transfers the heat to the cooling block 32, and finally, the cooling fluid takes away the heat from the cooling block 32 to achieve the purpose of cooling the battery module 20.

The battery device 100 employs the heat dissipation unit 30 to cool the battery module 20. The two battery packs 23 of the battery-pair structure 21 in the battery module 20 are arranged at two different sides of the cooling block 32. The heat conductive element 31 and the connecting portion 33 are used to transmit the heat generated by two battery packs 23 of the battery-pair structure 21 to the cooling block 32. The cooling path of the battery device 100 is shortened, the structure and assembly of the heat dissipation unit 30 is simplified, and the efficiency of the heat dissipation for the battery device 100 is ensured.

Meanwhile, inside the battery pack 23, the electrically-insulated heat conductive pads 236 are close to the battery cells 231 and the heat conductive plates 232 are close to the electrically-insulated heat conductive pads 236, to ensure that the heat generated by the battery cells 231 can be efficiently transmitted to the outside of the battery packs 23, thereby to ensure the heat dissipation efficiency.

The embodiments shown and described above are only examples. Many details are often found in the art such as the other features of a battery device and battery packs. Therefore, many such details are neither shown nor described. Even though numerous characteristics and advantages of the present technology have been set forth in the foregoing description, together with details of the structure and function of the present disclosure, the disclosure is illustrative only, and changes can be made in the details, especially in matters of shape, size, and arrangement of the parts within the principles of the present disclosure, up to and including the full extent established by the broad general meaning of the terms used in the claims. It will therefore be appreciated that the embodiments described above can be modified within the scope of the claims.

What is claimed is:

1. A battery pack comprising:
a housing with a plurality of heat dissipating grooves;
a plurality of battery cells received in the housing comprising:
a plurality of electrically-insulated heat conductive pads received in the heat dissipating grooves; and
at least one heat conductive plate with a plurality of first protrusions; and
an electrical connection plate module used to electrically connect the plurality of battery cells,
wherein the heat conductive plate is mounted on the housing, the first protrusions extend into the heat dissipating groove to press the electrically-insulated heat conductive pads close to the electrical connection plate module.

2. The battery pack according to claim 1, wherein the material of electrically-insulated heat conductive pads is selected from silicone, rubber, or polymer.

3. The battery pack according to claim 1, wherein the shape of the electrically-insulated heat conductive pads is an elongated strip shape.

4. The battery pack according to claim 1, wherein the housing further comprises at least one first receiving groove communicated with the heat dissipating groove, the first receiving groove is far from the battery cells corresponding to the heat dissipating groove and the heat conductive plate is received in the first receiving groove.

5. The battery pack according to claim 1, wherein the heat conductive plate comprising an second inner surface and an second outer surface opposite to the second inner surface, the second outer surface is flat and the second inner surface with a plurality of the first protrusions.

6. The battery pack according to claim 1, wherein the battery pack further comprises an outer cover which is mounted on the housing and covers the heat conductive plate and a second receiving groove is formed between the outer cover and the heat conductive plate.

7. A battery device comprising:
a base;
a heat dissipation unit; and
a battery module disposed on the base comprising:
a battery-pair structure comprising:
two battery packs which stand side by side and spaced from each other,
the battery pack comprising:
a housing with a plurality of heat dissipating grooves;
a plurality of battery cells received in the housing comprising:
a plurality of electrically-insulated heat conductive pads received in the heat dissipating grooves; and
at least one heat conductive plate with a plurality of first protrusions; and
an electrical connection plate module used to electrically connect the plurality of battery cells,
wherein the heat conductive plate is mounted on the housing, the first protrusions extend into the heat dissipating groove to press the electrically-insulated heat conductive pads close to the electrical connection plate module,
wherein the heat dissipation unit includes at least one heat conductive element corresponding to the battery-pair structure, the heat conductive element is across the gap between the two battery packs and connects to the heat conductive plate corresponding to the battery-pair structure, each of the heat conductive element includes a plurality of strip-shaped heat conductive members, the heat conductive members are at a divergent state on the heat conductive plate of the battery pack, and are at a concentrated state between intervals of the battery packs.

8. The battery device according to claim 7, wherein the shape of electrically-insulated heat conductive pads is an elongated strip shape.

9. The battery device according to claim 7, wherein the housing further comprises at least one first receiving groove communicated with the heat dissipating groove, the first receiving groove is far from the battery cells corresponding to the heat dissipating groove and the heat conductive plate is received in the first receiving groove.

10. The battery device according to claim 7, wherein the heat conductive plate comprising an second inner surface and an second outer surface opposite to the second inner surface, the second outer surface is flat and the second inner surface with a plurality of the first protrusions.

11. The battery device according to claim 7, wherein the battery pack further comprises an outer cover which is mounted on the housing and covers the heat conductive plate and a second receiving groove is formed between the outer cover and the heat conductive plate

12. The battery device according to claim 7, wherein the heat conductive member is a heat pipe.

13. The battery device according to claim 7, wherein the heat dissipation unit comprises a cooling block and a connecting portion connecting with the heat conductive element and the cooling block, wherein the connecting portion is used to transmit the heat generated by the battery module to the cooling block.

14. The battery device according to claim 13, wherein the connecting portion is disposed within a gap between the battery packs of the battery-pair structure, and the ends of the connecting portion connect a portion of the heat conductive element which the portion of the heat conductive element is across the gap between the battery packs.

15. A battery pack for use in a battery module comprising:
a housing defining an interior space, the housing having a first outer surface and a first inner surface, with the first inner surface bordering the interior space;
a plurality of battery cells received in the interior space of the housing;
an electrical connection plate electrically connecting the plurality of battery cells;
a plurality of electrically-insulated heat conductive pads; and
at least one heat conductive plate attached to the first outer surface of the housing;
wherein the at least one heat conductive plate has a second inner surface facing the housing with a plurality of first protrusions extending outward from the second inner surface;
wherein there is a plurality of first receiving grooves including a plurality of open ends in the first outer surface and the first inner surface at the housing portion is adjacent to the electrical connection plate; and
wherein the plurality of electrically-insulating heat conducting pads are positioned in the plurality of heat dissipating grooves and held close to the electrical connection plates by the plurality of first protrusions of the heat conductive plate sliding through the open ends.

16. The battery pack according to claim 15, wherein the material of electrically-insulated heat conductive pads is selected from silicone, rubber, or polymer.

17. The battery pack according to claim 15, wherein the first receiving groove is far from the battery cells corresponding to the heat dissipating groove.

18. The battery pack according to claim 15, wherein the heat conductive plate further comprising an second outer surface opposite to the second inner surface, the second outer surface is a flat surface.

19. The battery pack according to claim 15, wherein the battery pack further comprises an outer cover which is mounted on the housing and covers the heat conductive plate and a second receiving groove is formed between the outer cover and the heat conductive plate.
